(19) United States
(12) Patent Application Publication
(10) Pub. No.: US 2004/0203503 A1
(43) Pub. Date: Oct. 14, 2004

(54) Portable electronic apparatus

(76) Inventors: Thomas James Rollins, Boynton Beach, FL (US); Bruce Mckay Morton, Snohomish, WA (US); Charles Austin Murphy, Austin, TX (US)

Correspondence Address: Randi L. Dulaney, Motorola, Inc., Law Department, 8000 West Sunrise Boulevard, Fort Lauderdale, FL, 33322, US

(21) Appl. No.: 10/160,618

(22) Filed: May 31, 2002

(51) Int. Cl. H04B 1/38

(52) U.S. Cl. 455/90.3; 455/66.1

(57) ABSTRACT

A portable electronic apparatus (100, 1000) includes a housing wall (116, 516, 916, 1012), and a piezoelectric transducer (118) unitized with the housing wall (116, 516, 916, 1012). The housing wall (116, 516, 1012) can be overmolded with the piezoelectric transducer (118) or the piezoelectric transducer (118) can be bonded to the wall (916). The portable electronic apparatus can for example comprise a watch (100) or a wireless communication device (1000). The piezoelectric transducer (118) can be driven to vibrate so as to produce a perceptible tactile or audible alert. The geometry of the piezoelectric transducer (118) and the manner in which it is integrated with the electronic apparatus (100, 1000) are such that only a small volume is required to accommodate the piezoelectric transducer (118).

### BACKGROUND OF THE INVENTION

1. Field of the Invention

This invention relates in general to electrical apparatus and particularly to acoustic and vibratory alerts for portable electronic devices.

2. DESCRIPTION OF RELATED ART

Recently portable electronic apparatuses of various types including pagers, two-way pagers, cellular telephones, portable digital assistants, (PDA) and advanced digital watches have proliferated. In the design of portable electronic apparatus, the reduction of the space occupied by internal components is often a paramount consideration. In such devices, it is also desirable to include electromechanical transducers that are capable of causing vibrations and transducers that are capable of emitting audio signals. The former are useful in implementing vibratory alerts, and the latter are useful for implementing audio alerts, and in some cases for emitting more complex audio signals such as voice or music.

Particularly, in some of the more compact and feature rich portable electronic devices such as advanced digital watches it is difficult to find space to accommodate all the components that are desired, without making the apparatus excessively bulky.

### BRIEF DESCRIPTION OF THE FIGURES

The present invention will be described by way of exemplary embodiments, but not limitations, illustrated in the accompanying drawings in which like references denote similar elements, and in which:

FIG. 1 is an exploded view of a wrist watch form factor electronic apparatus according to a first alternative embodiment of the invention.

FIG. 2 is a sectional elevation view of a lower housing part of the electronic apparatus shown in FIG. 1 according to the first alternative embodiment of the invention.

FIG. 3 is a magnified view of a portion of the sectional elevation view shown in FIG. 2.

FIG. 4 is an exploded view of a piezoelectric transducer that is included in the electronic apparatus shown in FIGS. 1, 2 and 3.

FIG. 5 is a sectional elevation view of a lower housing part of the electronic apparatus shown in FIG. 1 according to a second alternative embodiment of the invention.

FIG. 6 is a magnified view of a portion of the sectional elevation view shown in FIG. 5.

FIG. 7 is a perspective view of a lower housing part of the electronic apparatus shown in FIG. 1 according to a preferred embodiment of the invention.

FIG. 8 is a sectional elevation view of the lower housing part shown in FIG. 7.

FIG. 9 is a perspective view of a lower housing part of the electronic apparatus shown in FIG. 1 according to a third alternative embodiment of the invention.

FIG. 10 is a perspective view, with a broken out portion, of a wireless communication device according to a fourth alternative embodiment of the invention.

FIG. 11 is a magnified view of a portion of the perspective view shown in FIG. 10.

FIG. 12 is a sectional plan view of the wireless communication device shown in FIG. 0.

FIG. 13 is a functional block diagram of the electronic apparatus shown in FIG. 1 according to the preferred embodiment of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

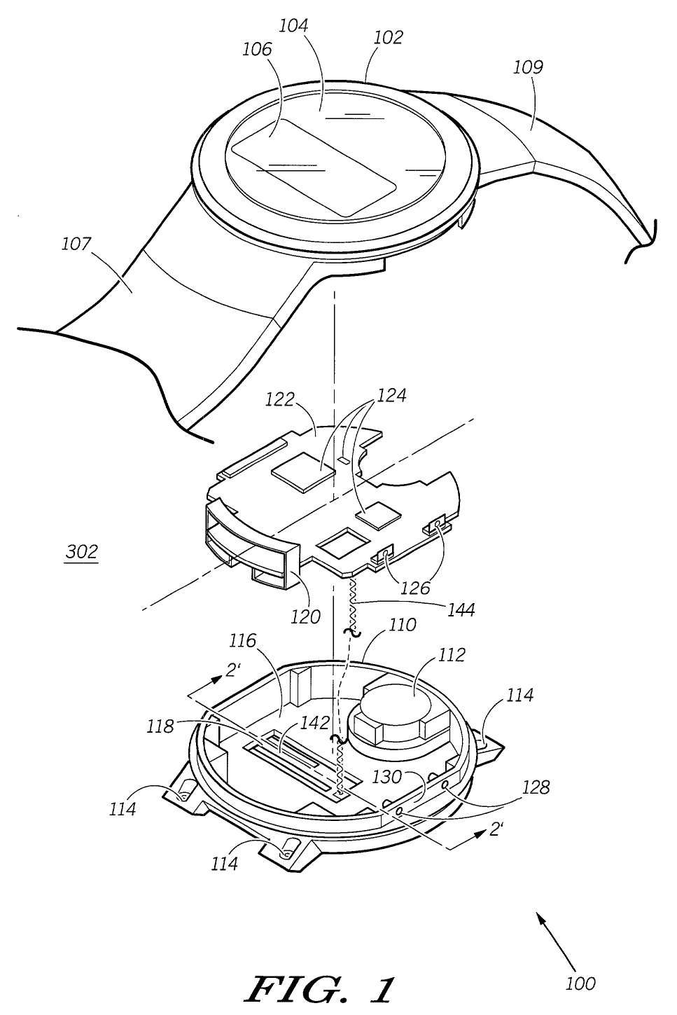

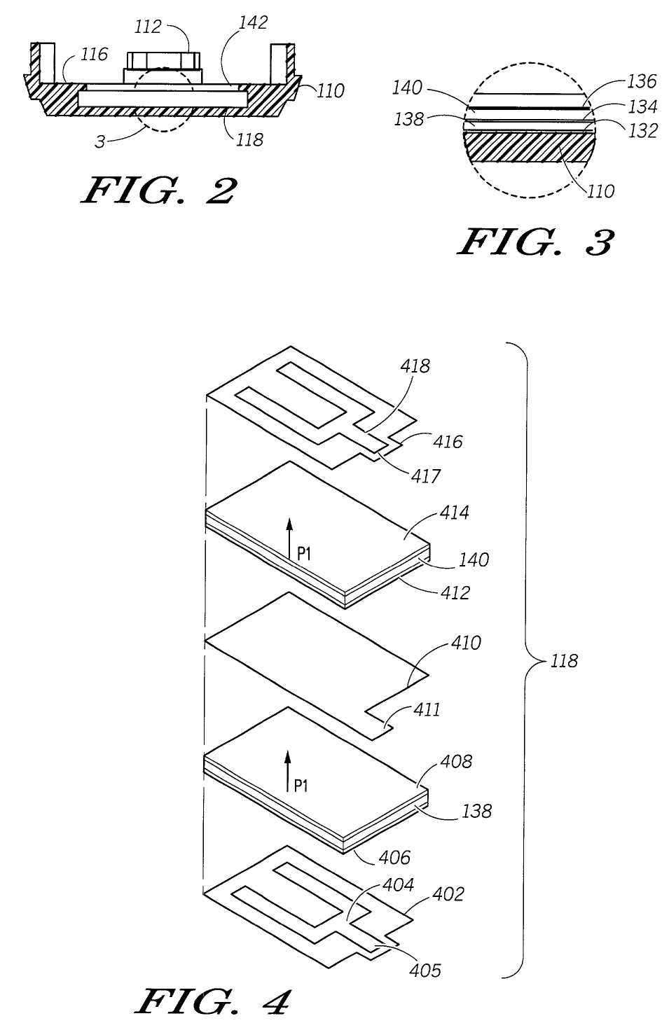

FIG. 1 is an exploded view of a wrist watch form factor electronic apparatus 100 according to a first alternative embodiment of the invention and FIG. 2 is a sectional elevation view of a lower housing part 110 of the wrist watch form factor electronic apparatus shown in FIG. 1. FIG. 3 is a magnified view of a portion of the sectional elevation view shown in FIG. 2. The electronic apparatus 100 preferably comprises a wireless communication device. The electronic apparatus 100 includes an upper housing part 102 that includes a crystal (face plate) 104. A liquid crystal display (LCD) 106 is mounted below the crystal 104. A first half of a wrist strap 109, and a second half of the wrist strap 107 are attached to the upper housing part 102. A lower housing part 110 that is adopted for mating with the upper housing part 102 is also provided. The lower housing part 110 includes a battery compartment 112. The lower housing part 110 includes a number of screw holes 114 through which screws (not shown) are passed in order to secure the lower housing part 110 to the upper housing part 102.

The lower housing part 110 includes a flat wall 116. A piezoelectric transducer 118 is unitized with the flat wall 116. The lower housing part 110 is preferably plastic that is overmolded with the piezoelectric transducer 118 included. The piezoelectric transducer 118 is exposed to an interior of the electronic apparatus 100 thorough an opening 142 in the lower housing part 110. Not covering the piezoelectric transducer 118, improves the ability of the piezoelectric transducer 118 to flex.

The piezoelectric transducer 118 includes a first electrode 132, a second electrode 134, and a third electrode 136. A first piezoelectric layer 138 and a second piezoelectric layer 140 are located between the first electrode 132 and the third electrode 136. The second electrode 134 is located between the first 138 and second 140 piezoelectric layers. The first 132 and second 136 electrodes are preferably electrically coupled together. The first 138 and second 140 piezoelectric layers are preferably characterized by a common polarization direction, that is perpendicular to the layers 138, 140 (out of plane of layers perpendicularly). Therefore, by applying a first potential to the first 132 and third 136 electrodes, and a second potential to the second electrode 134, by the action of the piezoelectric effect, one of the piezoelectric layers 138, 140 will be induced to contract, whilst the other of the piezoelectric layers 138, 140 is induced to expand. In as much as the piezoelectric layers 138, 140 are attached through the second electrode 134, in order to accommodate the expansion of one of the piezoelectric layers 138, 140 and simultaneous contraction of the other of the piezoelectric layers 138, 140 the piezoelectric transducer 118 will be caused adopt a concave or convex shape. Which layer 138, 140 expands, and which layer 138, 140 contracts depends on the polarization vector direction, and the sign of a potential difference between the aforementioned first and second potentials. By changing the sign of the potential difference, the piezoelectric transducer 118 can be caused to assume a concave or convex shape. By applying an oscillating potential difference, the piezoelectric transducer 118 is caused to vibrate. In as much as the piezoelectric transducer 118 is molded into the lower housing part 110 that is in contact with a user's wrist when the electronic apparatus 100 is in use, vibration of the piezoelectric transducer 118 will be felt by the user. Thus, an alert is provided. The piezoelectric transducer 118 can for example be used to alert the user at a predetermined time (i.e., for an alarm function), or to alert the user that a page was been received by the electronic apparatus 100. By using a low frequency driving signal a perceptible tactile alert is produced. In order to provide a tactile alert, the transducer 118 is preferably driven with a frequency in the range of about 70 to about 250 Hertz. More preferably, a driving signal having a frequency of about 120 Hertz is used. Tactile alerts are advantageous, in that the user can be alerted discretely, i.e., without distracting other persons in the vicinity. By integrating the piezoelectric transducer 118 with the lower housing part 110, the need to increase the size of the electronic apparatus 100 in order to include a conventional tactile alert is avoided.

By driving the piezoelectric transducer 118 with an oscillating signal that is in the audio frequency range, the piezoelectric transducer 118 is induced to emit an audible sound e.g., a beep. Thus, the piezoelectric transducer 118 is capable of providing either tactile or audible alerts depending on the signal with which it is driven. Alternatively, the piezoelectric transducer can be driven with an audio signal that includes voice, music or other complex sounds. A frequency range of about 300 to 4000 Hz is suitable for voice signals.

The upper and lower housing parts 102, 110 house a number of components including the LCD 106, a folded conductor antenna 120, and a circuit substrate 122. The circuit substrate 122 supports, and interconnects a plurality of circuit components 124 and switches 126. The switches 126 are actuated via buttons 128 that penetrate through a side wall portion 130 of the lower housing part 110. The switches 126 are used for configuring (e.g., setting an alarm time) and controlling the operation of the electronic apparatus 100. Electrical circuits that are embodied in the circuit components 124, and interconnections thereof, preferably include one or more circuits for driving the piezoelectric transducer 118. A pair of signal leads 144 connect the piezoelectric transducer 118 to the circuit substrate 122. One of the pair of signal leads 144 is coupled to the first 132 and third 136 electrode, and the other of the pair of signal leads 144 is coupled to the second electrode 134.

FIG. 4 is an exploded view of the piezoelectric transducer 118 that is included in the electronic apparatus 100 shown in FIGS. 1 and 2. As shown in FIG. 4, the piezoelectric transducer 118 includes a lower mylar substrate 402 that supports a first pattern of copper traces 404. The first piezoelectric layer 138 includes a first silver layer 406 on a first surface that faces the lower mylar substrate 402, and a second silver layer 408 on an opposite surface. Note that the first pattern of conductive traces 404 faces the first silver layer 406. A brass shim 410 is interposed between the first piezoelectric layer 138, and the second piezoelectric layer 140. The second piezoelectric layer 140 has a third silver layer 412 on a first surface that faces the brass shim 410, and a fourth silver layer 414 on an opposite surface. An upper mylar substrate 416 faces the fourth silver layer 414. The upper mylar substrate 416 supports a second pattern of copper traces that faces the fourth silver layer 414. When the piezoelectric transducer 118 is assembled, the first pattern of conductive traces 404 makes electrical contact with the first silver layer 406, the brass shim 410 makes electrical contact with the second silver layer 408 and the third silver layer 412, and the second pattern of conductive traces 418 is in electrical contact with the fourth silver layer 414. The first pattern of conductive traces 404 includes a first segment 405 that extends on the lower mylar substrate 402 out beyond a periphery of the first and second piezoelectric layers 138, 140. Similarly, the second pattern of conductive traces 418 includes a second segment 417 that partially overlies the first segment 405. In the assembled piezoelectric transducer 118, the first segment 405 and the second segment 417 are brought together to establish electrical contact. A portion of the first segment 405 that extends beyond the second segment 417 can be used as a terminal for connection to the aforementioned one or more driving circuits. Connection to the first segment 405 can be made by soldering. The brass shim 410 includes a tab 411 that extends beyond the periphery of the first 138 and second 140 piezoelectric layers. The tab 411 serves as a terminal for connection to the aforementioned one or more driving circuits.

The first pattern of conductive traces 404 in combination with the first silver layer 406 serves as the first electrode 132 (FIG. 2). The brass shim 410 in combination with the second 408 and third 412 silver layers serves as the second electrode 134 (FIG. 2). The second pattern of conductive traces 418 in combination with the fourth silver layer 414 serves as the third electrode 136 (FIG. 2). The upper 416, and lower 402 mylar layers preferably extend beyond peripheries of the first 138 and second 140 piezoelectric layers, and the brass shim 410. Peripheral portions of the upper and lower mylar layers 402, 416 are preferably bonded together in the assembled piezoelectric transducer 118.

The piezoelectric transducer 118 is substantially planar and has an overall thickness that is small compared to its plan view dimensions. Each of the piezoelectric layers 138, 140 are preferably from about 0.18 mm to 0.22 mm thick. The overall thickness of the piezoelectric transducer 118 is preferably in the range of 0.6 mm to 0.7 mm. The plan view dimension of the piezoelectric transducer 118 are preferably equal to a substantial fraction of the plan view dimensions of the lower housing part 110 of the electronic apparatus 100. Quantitatively, each of the plan view dimensions is preferably in the range of about 1 to 3.5 cm. Because the piezoelectric layers 138, 140 are well suited to making the piezoelectric transducer 118 very thin, the piezoelectric transducer 118 can be easily integrated with the flat wall 116 of the lower housing part 110. More generally, the thinness of the piezoelectric transducer 118 makes it suitable for inclusion in a variety of portable electronic devices in which space is limited. The planar geometry of the piezoelectric transducer 118 makes it suitable for incorporation within the lower housing part 110 wall 116.

The common polarization direction P1 of the two piezoelectric layers 138, 140 is indicated in FIG. 4. Alternatively, the two piezoelectric layers 138, 140 are give antiparallel polarization directions. In the latter case, the brass shim 410 can be eliminated, and the resulting piezoelectric transducer can be driven by applying a signal between the first 132 and third 136 electrodes.

Piezoelectric transducers of the general type shown in FIGS. 1-3 are available from Active Control Experts of Cambridge MA.

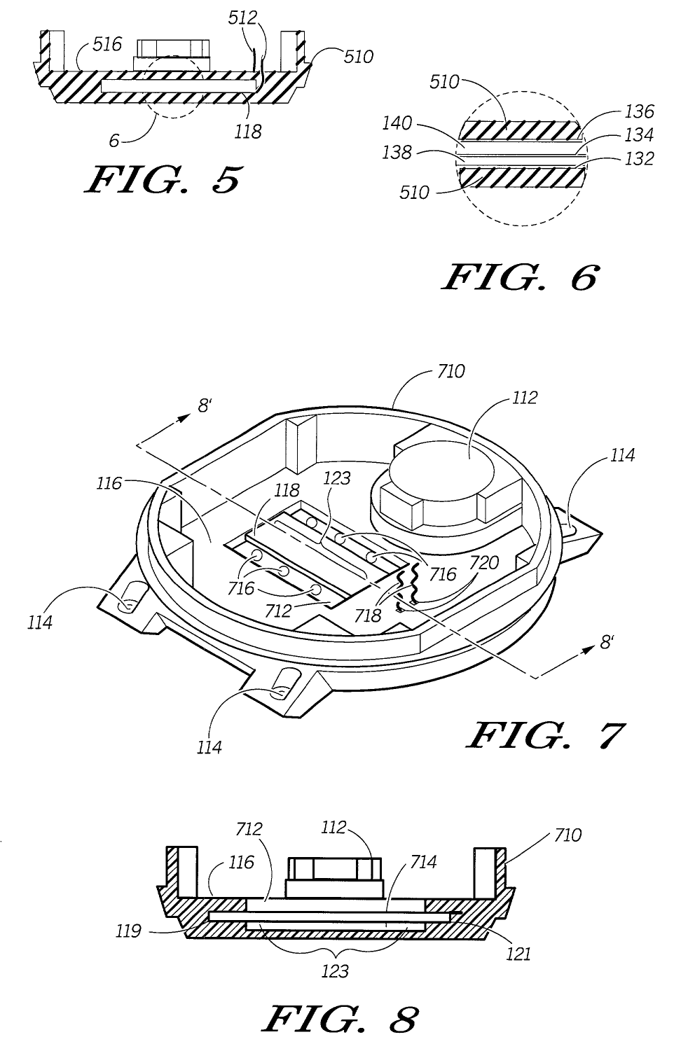

FIG. 5 is a sectional elevation view of a lower housing part 510 of the electronic apparatus 100 shown in FIG. 1 according to a second alternative embodiment of the invention, and FIG. 6 is a magnified view of a portion of the sectional elevation view shown in FIG. 5. According to the second alternative embodiment, the lower housing part 510 is made of molded rubber. In the second alternative embodiment, the piezoelectric transducer 118 is also unitized with a flat wall 516 of the lower housing part 510. As shown in FIG. 5, the piezoelectric transducer 118 is embedded within and surrounded by the rubber of the lower housing part 510. The rubber lower housing part 510, being rubber, is very flexible and thus readily allows the piezoelectric transducer 118 to contort (e.g., assume a concave or convex shape) when a driving signal is applied. A pair of signal leads 512 pass out from the transducer 118 through the rubber of the lower housing part 510 for connection to the circuit substrate 122.

FIG. 7 is a perspective view of a lower housing part 710 of the electronic apparatus 100 shown in FIG. 1 according to a preferred embodiment of the invention and FIG. 8 is a sectional elevation view of the lower housing part shown in FIG. 7. In the preferred embodiment, the piezoelectric transducer 118 is also unitized with the flat wall 116. The preferred lower housing part 710 includes a recess 712 that is deeper than a height of the piezoelectric transducer 118. The piezoelectric transducer 118 includes a first end 119 and a second end 121 that are embedded in the lower housing part 710. A midsection 123 of the piezoelectric transducer 118 is suspended across the recess 712. A gap 714 exists between the midsection 123 of the piezoelectric transducer 118, and the lower housing part 710. A plurality of through holes 716 extend from a bottom of the recess 712. Suspending the midsection 123 of the piezoelectric transducer 118 across the recess 712 allows the piezoelectric transducer 118 to more easily contort when driven by a driving signal. Providing the through holes 716 facilitates the radiation of acoustic waves to an external environment (e.g., to a user) when the piezoelectric transducer 118 is driven at acoustic frequencies. Proving the through holes 716 allows the combination of the upper 102 and lower 710 housing parts to function as an acoustic Hemholtz resonator. Alternatively, the holes 726 can be eliminated in the interest of excluding water from the electronic apparatus 100. A pair of signal leads 718 extend through openings 720 in the flat wall 116 and make contact with the tab 411 of the brass shim 410, and the first segment 405 of the first pattern of conductive traces 404.

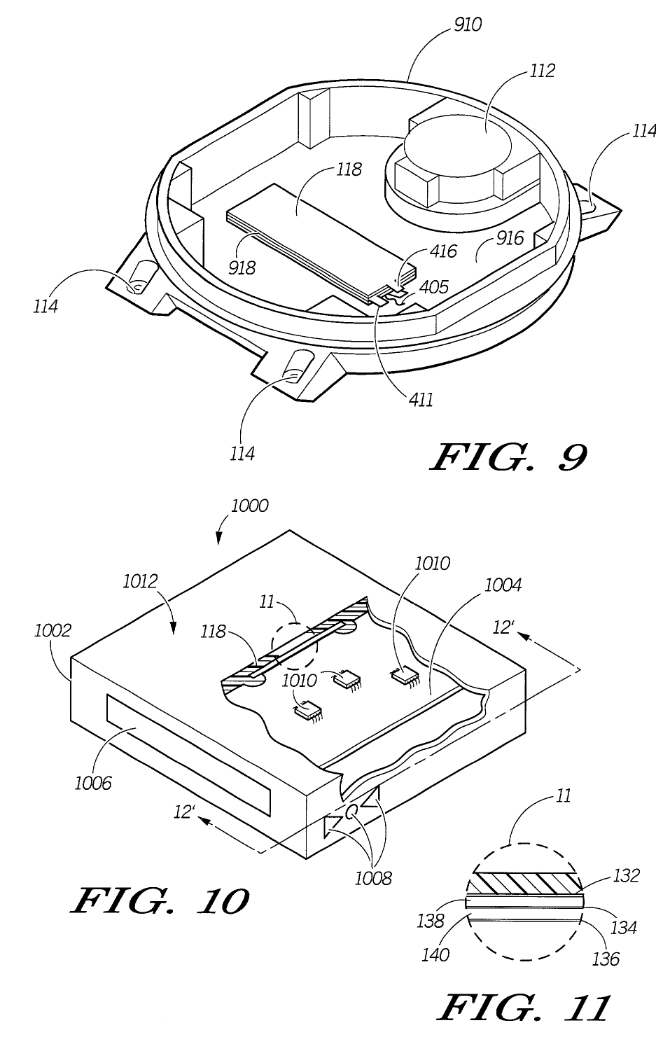

FIG. 9 is a perspective view of a lower housing part 910 of the electronic apparatus 100 shown in FIG. 1 according to a third alternative embodiment of the invention. The lower housing part 910 comprises a substantially flat bottom wall 916. The piezoelectric transducer 118 is unitized with the flat bottom wall 916 by being bonded to the flat bottom wall 916, using a bonding agent 918 such as an epoxy glue. Because the piezoelectric transducer 118 is thin, it can be accommodated on the flat bottom wall 916 without taking up a substantial amount of space in the electronic apparatus 100.

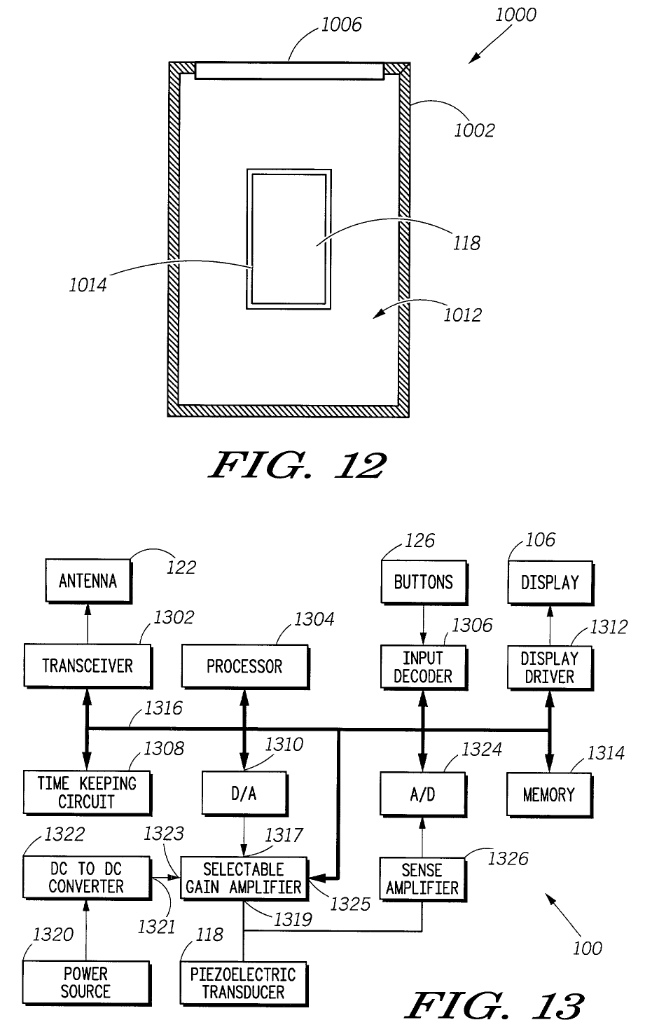

FIG. 10 is a perspective view, with a broken out portion, of a wireless communication device 1000 according to a fourth alternative embodiment of the invention, FIG. 11 is a magnified view of a portion of the perspective view shown in FIG. 10, and FIG. 12 is a sectional plan view of the wireless communication device shown in FIG. 10. The wireless communication device 1000 includes a housing 1002. The housing 1002 encloses and supports a number of parts including a circuit substrate 1004, a LCD 1006, and a plurality of control buttons 1008. The circuit substrate 1004 supports and interconnects a number of circuit components 1010. The circuit components 1010 and interconnections thereof preferably embody an electrical circuit that includes a receiver, one or more piezoelectric transducer drive circuits, and a processor. The housing 1002 includes a flat wall 1012. The piezoelectric transducer 118 is unitized with the flat wall 1012. The piezoelectric transducer 118 is preferably overnolded into the flat wall 1012 of the housing 1002. The piezoelectric transducer 118 is exposed to an interior of the housing 1002 through an inward facing opening 1014 of the flat wall 1012.

FIG. 13 is a functional block diagram of the electronic apparatus 100 shown in FIG. 1 according to the preferred embodiment of the invention. As shown in FIG. 13, the electronic apparatus 100 comprises a transceiver 1302, a processor 1304, an input decoder 1306, a time keeping circuit 1308, a digital to analog converter 1310, a display driver 1312, an analog to digital converter 1324 and a memory 1314 coupled together through a digital signal bus 1316. The transceiver 1302 is coupled to the antenna 122. The processor 1304 is programmed to execute programs for controlling the operation of the electronic apparatus 100 that are stored in the memory 1314. The input decoder 1306 is coupled to the switches 126. The display driver 1312 is coupled to the display 106. The analog to digital converter 1324 is coupled to a sense amplifier 1326 that is coupled to the piezoelectric transducer 118.

The digital to analog converter 1310 is coupled to an input 1317 of a selectable gain amplifier 1318. A digital gain control input 1325 of the selectable gain amplifier 1318 is coupled to the processor 1304 through the digital signal bus 1316. A power source 1320, that preferably takes the form of a battery stored in the battery compartment 112, supplies power at a relatively low voltage (e.g., 1.5 to 3 volts) to a DC-to-DC converter 1321. An output 1321A of the DC-to-DC converter 1320 is coupled to a power input 1323 of the selectable gain amplifier 1318. The DC-to-DC converter 1321 preferably supplies power to the selectable gain amplifier 1318 at a relatively high voltage (e.g., 10 to 50 volts) that is sufficient to allow the selectable gain amplifier 1318 to drive the piezoelectric transducer 118 with an amplitude that is sufficient to cause the generation of perceptible tactile and audible vibration. Although a voltage required to obtain perceptible tactile or audible response from the piezoelectric transducer 118 may vary depending on the thickness and materials used in the piezoelectric transducer 118, it can be determined by routine experimentation. An output 1319 of the selectable gain amplifier 1319 is coupled to the piezoelectric transducer 118. The output 1319 of the selectable gain amplifier preferably comprises two terminals one of which is coupled to the first 132 and third 136 electrodes of the piezoelectric transducer 118 and another that is coupled to the second electrode 134 of the piezoelectric transducer 118. The transducer 118 is preferably driven with a voltage of at least about 24 volts in order to produce audible alerts and is preferably driven with a voltage of at least about 32 volts when it is desired to produce vibratory alerts.

The transceiver 1302, processor 1304, input decoder 1306, display driver 1312, time keeping circuit 1308, digital to analog converter 1310, analog to digital converter 1324, memory 1314, DC-to-DC converter 1321, selectable gain amplifier 1318, and sense amplifier 1326 are circuits that are embodied in the circuit components 124 and interconnections of the circuit substrate 122.

The sense amplifier 1326 and analog to digital converter 1324 can be used to sense electric signals that are generated by the piezoelectric transducer 118 when it is caused to vibrate by an externally generated vibration such as caused by the user's voice speaking to the electronic apparatus 100. In such a capacity, the piezoelectric transducer 118 takes the place of a microphone and can be used to input audio that is then transmitted by the transceiver 1302, and/or recorded in the memory 1314. The piezoelectric transducer 118 can also be used as a microphone in wireless communication device 1000 (FIG. 10).

The transceiver 1302 is operable to receive messages. The time keeping circuit 1308 is operable to keep time. The processor 1304 can be programmed to accept user input through the switches 126 of user selected alarm times. In response to receiving messages, or when an alarm time is reached, the processor 1304 selects a gain setting of the selectable gain amplifier 1318, and applies a signal to the selectable gain amplifier 1318 through the digital to analog converter 1310 in order to cause the selectable gain amplifier 1318 to drive the piezoelectric transducer 118 in order to generate a perceptible tactile or audible vibration or both. The gain setting to be used can be user configurable.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A portable electronic apparatus comprising:
a housing including a wall; and
a piezoelectric transducer unitized with the wall.

2. The portable electronic apparatus according to claim 1 wherein:
the piezoelectric transducer is overmolded into the wall.

3. The portable electronic apparatus according to claim 1 wherein:
the piezoelectric transducer is bonded to the wall.

4. The portable electronic apparatus according to claim 1 wherein:
the piezoelectric transducer is substantially planar.

5. The portable electronic apparatus according to claim 1 wherein the piezoelectric transducer at least partially overlies a recess in the wall such that there is a gap between at least a portion of the piezoelectric transducer and the wall.

6. The portable electronic device according to claim 1 wherein:
the wall comprises rubber.

7. The portable electronic apparatus according to claim 1 wherein:
the piezoelectric transducer is at least partially embedded in the wall.

8. The portable electronic device according to claim 1 comprising:
a wrist watch form factor electronic device wherein:
the wall comprises a wrist side wall of the wrist watch form factor electronic device.

9. The portable electronic device according to claim 8 further comprising:
an electric circuit including:
a driving circuit adapted to drive the piezoelectric transducer at a frequency in the range of 70 to 250 Hertz.

10. The portable electronic apparatus according to claim 8 wherein:
the wall comprises rubber.

11. The portable electronic apparatus according to claim 1 wherein:
the piezoelectric transducer comprises:
a first electrode;
a second electrode;
a first piezoelectric layer disposed between first electrode and the second electrode;
a second piezoelectric layer disposed between the first electrode and the second electrode.

12. The portable electronic device according to claim 11 further comprising;
a third electrode disposed between the first piezoelectric layer and the second piezoelectric layer; and
wherein the first electrode is connected to the second electrode.

13. The portable electronic device according to claim 1 further comprising:
an electric circuit including:
a driving circuit adapted to drive the piezoelectric transducer.

14. The portable electronic device according to claim 13 wherein
the electric circuit further comprises:
a transceiver for receiving one or more signals;
a processor coupled to the driving circuit for activating the driving circuit in response to the one or more signals.

15. A portable electronic apparatus comprising:
a housing including a wall that includes a piezoelectric transducer.

16. The portable electronic apparatus according to claim 15 wherein:
the piezoelectric transducer is overmolded into the wall.

17. The portable electronic apparatus according to claim 15 wherein:
the piezoelectric transducer is substantially planar.

18. The portable electronic apparatus according to claim 15 wherein the piezoelectric transducer at least partially overlies a recess in the wall such that there is a gap between at least a portion of the piezoelectric transducer and the wall.

19. The portable electronic device according to claim 1 wherein:
the wall comprises rubber.

20. The portable electronic device according to claim 15 further comprising:
an electric circuit including:
a driving circuit adapted to drive the piezoelectric transducer at a frequency in the range of 70 to 250 Hertz.
